(19) United States
(12) Patent Application Publication
(10) Pub. No.: US 2020/0302699 A1
(43) Pub. Date: Sep. 24, 2020

(54) Virtual Reality Anchored Annotation Tool

(71) Applicant: Intuitive Research and Technology Corporation, Huntsville, AL (US)

(72) Inventors: Chanler Crowe Cantor, Madison, AL (US); Michael Jones, Athens, AL (US); Kyle Russell, Huntsville, AL (US); Michael Yohe, Meridianville, AL (US)

(21) Appl. No.: 16/896,804

(22) Filed: Jun. 9, 2020

Related U.S. Application Data
(63) Continuation-in-part of application No. 16/191,911, filed on Nov. 15, 2018, now abandoned.
Application No. 16/191,911 is a continuation-in-part of application No. 16/428,372, filed on May 31, 2019.
(60) Provisional application No. 62/733,769, filed on Sep. 20, 2018.
(60) Provisional application No. 62/774,960, filed on Dec. 4, 2018.

(51) Int. Cl. G06T 19/20; G06T 11/60; G06T 11/00

(52) U.S. Cl. CPC G06T 19/20; G06T 11/60; G06T 11/001; G06F 3/04815; G06T 2219/2004; G06T 2219/2016; G06T 2219/2012; G06T 2219/004

(57) ABSTRACT

A method for making annotations on computer-readable media for image annotation allows for the three-dimensional annotation of a three-dimensional object to be anchored to the same location, rotation, or scale of the annotation relative to the object in a virtual reality, augmented reality, or mixed reality environment. A user uploads one or more two-dimensional images, and one or more two-dimensional representations of the images are made in a virtual space. A three-dimensional representation is created from the one or more two-dimensional representations. The user makes an annotation on either a two-dimensional representation or the three-dimensional representation within the virtual space to create an annotated representation. The annotation is then automatically translated to the two-dimensional representation or three-dimensional representation that was not annotated and displayed in real time in both the two-dimensional representation and three-dimensional representation.

### REFERENCE TO RELEATED APPLICATIONS

This application is a continuation-in-part of, and claims priority to, U.S. non-provisional application Ser. No. 16/191,911, entitled “Virtual Reality Anchored Annotation Tool” and filed on Nov. 15, 2018, which claims priority to Provisional Patent Application U.S. Ser. No. 62/733,769, entitled “Virtual Reality Anchored Annotation Tool” and filed on Sep. 20, 2018. This application is further a continuation-in-part of, and claims priority to, U.S. non-provisional application Ser. No. 16/428,372, entitled “Voxel Build” and filed on May 31, 2019, which claims priority to Provisional Patent Application U.S. Ser. No. 62/774,960, entitled “Voxel Build” and filed on Dec. 4, 2018. These applications are fully incorporated herein by reference.

### BACKGROUND AND SUMMARY

The disclosed embodiments relate generally to a multi-dimensional computing environment and, more particularly, to image annotation in a multi-dimensional computing environment.

Three-dimensional, virtual worlds provide a number of advantages over the non-virtual world in that they allow greater flexibility in development of training applications leveraging three-dimensional space over non-virtual, traditional computer-based methods with conventional input devices. Computer operators can develop and manipulate objects within virtual worlds in ways not possible in non-virtual environments. The ability to communicate thoughts and ideas within the medium of virtual worlds with various objects is quintessential to increase the efficacy of training, research, and other applications of virtual worlds. The use of three-dimensional virtual worlds to manipulate objects within a software environment will become prevalent in the future as they allow for greater cost efficiency and manipulative ability over the images than non-virtual methods.

Current virtual engines allow for objects to be attached using trees called Parent-child hierarchies, allowing objects to occupy a related space and maintain that relevance mathematically; however, they do not allow for virtual annotation tools that enable the operator to attach the three-dimensional annotation to the three-dimensional object in virtual space and maintain the location, rotation, and scale relationship between the annotation and the Object. The methods described herein allow for anchoring the location, rotation, and scale of the annotation with the location, rotation, and/or scale of the Object.

Presented herein are methods, systems, devices, and computer-readable media for image annotation allowing for the image to be attached to a three-dimensional Object. A three-dimensional Object may be created by an operator selecting the functions within a three-dimensional environment, and an Object may be generated by a system-generation of “ink points”, which link the three-dimensional annotation with the three-dimensional Object selected for annotation. In some embodiments, ink points will be used to maintain the relationship between the three-dimensional Object selected for annotation and the annotation created by the received user input, which may take the form of a highlighted note created by the user. In some embodiments, the annotation tool may draw the annotation in three-dimensional environment and connect that annotation with a three-dimensional Object. The annotation will be kept in the same location, rotation, and scale to the three-dimensional drawing created from the user input.

One embodiment of the tool would be for the operator to select a model representing a real-life analogue within a virtual world. These models can be made up of assemblies and subassemblies to make a system where one or more operators would use the annotation tool to select a system, an assembly, or subassembly to highlight specific characteristics of the object in the virtual world. The use of the annotation could be text, directional arrows, or other descriptive drawing that would serve as the annotation for the selected object. The operator would be able to describe the interfaces represented by the selected object as it relates to other objects. If the object were enlarged or rotated, the accompanying annotation would also be enlarged or rotated in relation to the selected object. The annotation would become a part of the selected object in the virtual world, allowing the annotation to be saved with the object or shared with another user in the same virtual world or another virtual world.

Another embodiment of the tool would be for the operator to select a three-dimensional protein in a virtual world. The operator may then use the annotation tool to select a ligand in the protein. The operator may use the annotation tool to highlight the particular ligand within the protein and use the annotation tool to write an annotation in three-dimensional space. After the three-dimensional annotation is written, the annotation is comprised of “Virtual Ink.” The “Virtual Ink” and the ligand are connected by the Parent-Child hierarchy in location, distance, and size from the selected ligand. If the ligand is then enlarged or rotated, the annotation will also be enlarged or rotated in relation to the atom. The annotation may then be saved or shared with another user in three-dimensional space.

In one embodiment, the user will be able to annotate the 2D representations and the annotation will also be applied to the portion of the portion of a 3D mesh corresponding to the 2D image. This capability will allow for the doctors to scrub through all of the 2D images from a patient scan and mark them up as they currently do. However, with the linking of the 2D images and the creation of the 3D meshes based on the 2D images, the doctors or medical professionals can link their annotations of the 2D images to the 3D representations. For example, if a user circles an area of interest on Slice 12 of the scans then the same area of interest will be circled on the 3D mesh representation. This capability will allow doctors or medical professionals to more thoroughly examine areas of interest by viewing them in three dimensions.

### BRIEF DESCRIPTION OF THE DRAWINGS

The disclosure can be better understood with reference to the following drawings. The elements of the drawings are not necessarily to scale, emphasis instead being placed upon clearly illustrating the principles of the disclosure. Furthermore, like reference numerals designate corresponding parts throughout the several views.

FIG. 1 depicts a system for annotating an Object according to an embodiment of the present disclosure.

FIG. 2 depicts a method for annotating a virtual reality image according to an exemplary embodiment of the present disclosure.

FIG. 3 depicts a method for generating an annotation, according to an exemplary embodiment of the present disclosure.

FIG. 4 illustrates the relationship between three-dimensional assets, the data representing those assets, and the communication between that data and the software, which leads to the representation on the XR platform.

FIG. 5 is a flow diagram describing an example of the process of the graphical tool input generating and orienting the ink points.

FIG. 6 is a flow diagram describing the process of the annotation creation and attachment to the Object.

FIG. 7A is a figure illustrating an example of a virtual three-dimensional Object.

FIG. 7B is a figure illustrating an example of the three-dimensional Object chosen for selection and the selection of an aspect of the object to receive the annotation according to an embodiment of the present disclosure.

FIG. 7C is a figure illustrating an embodiment of a highlighter tool according to an embodiment of the present disclosure.

FIG. 7D is a figure illustrating an example of the highlighter tool making an annotation relating to the selected aspect of the three-dimensional Object according to an embodiment of the present disclosure.

FIG. 7E is a figure illustrating the rotation of the object and the simultaneous rotation of the annotation in relation to the three-dimensional object according to an embodiment of the present disclosure.

FIG. 8 depicts a method for importing and analyzing data according to a threshold or range of values, in accordance with an exemplary embodiment of the present disclosure.

FIG. 9 depicts a method of creating the voxel representation of the uploaded series of images according to an exemplary embodiment of the present disclosure.

FIG. 10 depicts a method of linking or translating the annotations made on a two-dimensional representation to a three-dimensional representation.

FIG. 11 depicts a method of translating a two-dimensional representation annotation location to a three-dimensional representation location,

FIG. 12 depicts a method of linking or translating annotations made on a three-dimensional representation to a two-dimensional representation.

FIG. 13 depicts an exemplary method of converting two-dimensional space annotations to three-dimensional space annotations.

FIG. 14 depicts an exemplary method of converting three-dimensional space annotations to two-dimensional space annotations.

FIG. 15 depicts an exemplary annotated two-dimensional image next to a corresponding annotated three-dimensional representation in a virtual space, created using the method disclosed herein.

FIG. 16 depicts a deck of two-dimensional images next to a corresponding three-dimensional voxel mesh in a virtual space.

### DETAILED DESCRIPTION

In some embodiments of the present disclosure, the operator may use a virtual controller to annotate three-dimensional images. As used herein, the term “XR” is used to describe Virtual Reality, Augmented Reality, or Mixed Reality displays and associated software-based environments. As used herein, “Object” is used to describe a three-dimensional object in a virtual world, including, but not limited to, systems, assemblies, subassemblies, cabling, piping, landscapes, avatars, molecules, proteins, ligands, or chemical compounds. As used herein, “annotation” is used to describe a drawing, text, or highlight used to describe or illuminate the Object to which it is linked.

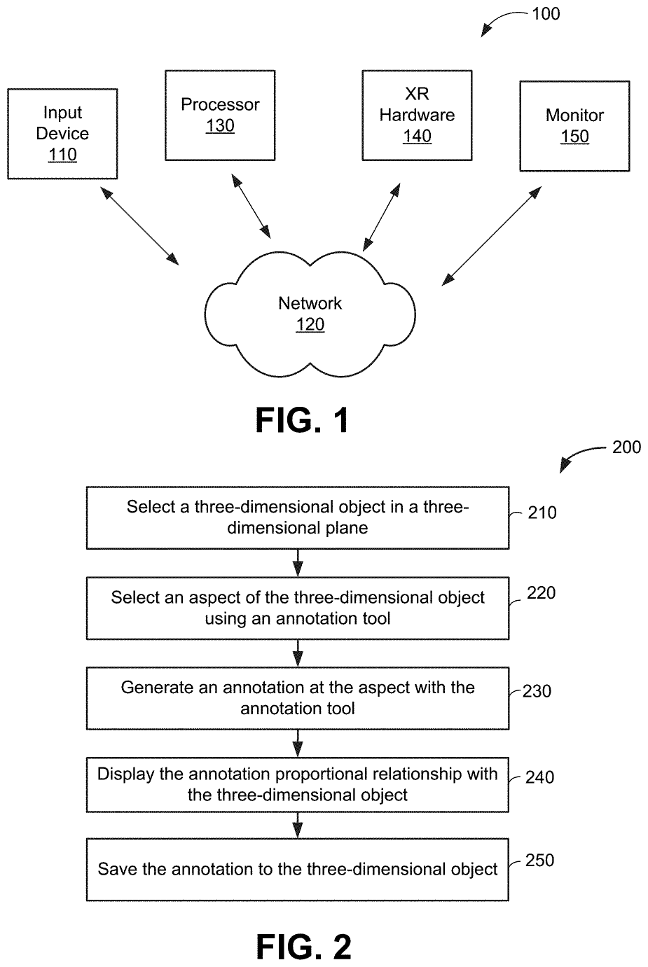

FIG. 1 depicts a system 100 for annotating an Object (not shown), according to an exemplary embodiment of the present disclosure. The system 100 comprises an input device 110 communicating across a network 120 to a processor 130. The input device 110 may comprise, for example, a keyboard, a switch, a mouse, a joystick, a touch pad and/or other type of interface, which can be used to input data from a user (not shown) of the system 100. The network 120 may be of any type network or networks known in the art or future-developed, such as the internet backbone, Ethernet, Wifi, WiMax, and the like. The network 120 may be any combination of hardware, software, or both.

The system 100 further comprises XR hardware 140, which may be virtual or mixed reality hardware that can be used to visualize a three-dimensional world, for example XR headsets, augmented reality headset systems, and augmented reality-based mobile devices, such as tablets and smartphones.

The system 100 further comprises a video monitor 150 is used to display the Object to the user.

In operation of the system 100, the input device 110 receives input from the processor 130 and translates that input into an XR event or function call. The input device 110 allows a user to input data to the system 100, by translating user commands into computer commands.

FIG. 2 depicts a method 200 for annotating an image according to an exemplary embodiment of the present disclosure. In step 210, a user selects a three-dimensional object in a three-dimensional plane. To select the three-dimensional object, the user uses an input device 110 (FIG. 1), for example, a computer mouse. In step, 220, the user selects a particular aspect of the three-dimensional object using an annotation tool (not shown). Although the illustrated method describes step 210 and step 220 as separate steps, in other embodiments the user may select a particular aspect of the object without first selecting the object itself.

In step 230, the user uses the annotation tool to generate an annotation at the aspect. The position and orientation of the annotation tool as actuated by the user determines the annotation. For example, the user may move a mouse to draw freehand text onto the Object. For another example, a three-dimensionally-tracked controller can be used to annotate at the aspect

In step 240, the annotation is displayed and viewed in the same relationship in size and location with respect to the three-dimensional object. This is true regardless of any manipulation performed on the three-dimensional object.

In step 250, the annotation is saved to the three-dimensional object.

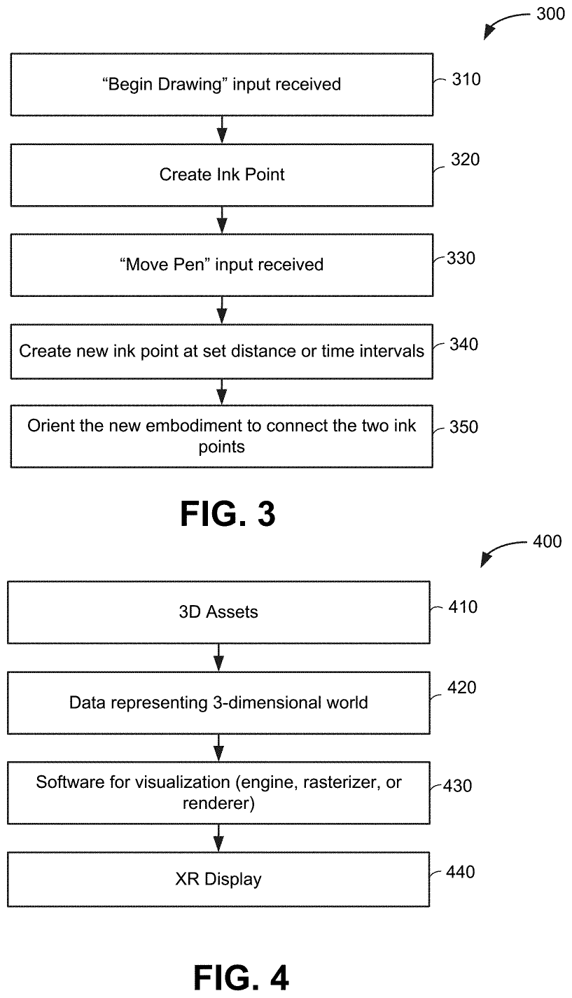

FIG. 3 depicts a method 300 for carrying out the step 230 of FIG. 2, according to an exemplary embodiment of the present disclosure. As discussed above, in step 230, the user uses the annotation tool to generate an annotation at the aspect of the object. In the method 300, virtual ink points are created using the annotation tool, as discussed herein.

In step 310, the input device 110 (FIG. 1) receives information from the user that signals the processor 130 to begin the creation of an annotation (drawing). In step 320, the virtual ink points (not shown) are created. An ink point is a point in space that defines an origin of a mesh, or a point along a spline, for use with a spline point, particle trail, mesh, or other representation of ink or drawing/painting medium.

In step 330, the processor 130 (FIG. 1) receives information from the input device 110 (based on the user controlling the input device) to move the annotation tool to a new position/orientation. In step 340, as the input device 110 sends input to move the annotation tool, new ink points are created at set distance and relational intervals. The processor 130 receives this input and creates additional ink points as the “Move Pen” input continues. In step 350, the processor 130 orients and connects the additional ink points.

FIG. 4 illustrates the relationship between three-dimensional assets, the data representing those assets, and the communication between that data and the software, which leads to the representation on the XR platform. Three dimensional assets 410 may be any three-dimensional assets, which are any set of points that define geometry in three-dimensional space. The data representing a three-dimensional world 420 is a three-dimensional mesh that may be generated by importing three dimensional models, images representing two-dimensional data, or other data converted into a three-dimensional format. The software for visualization 430 of the data representing a three-dimensional world 420 allows for the processor 130 (FIG. 1) to facilitate the visualization of the data representing a three-dimensional world 420 to be depicted as three-dimensional assets 410 in the XR display 440.

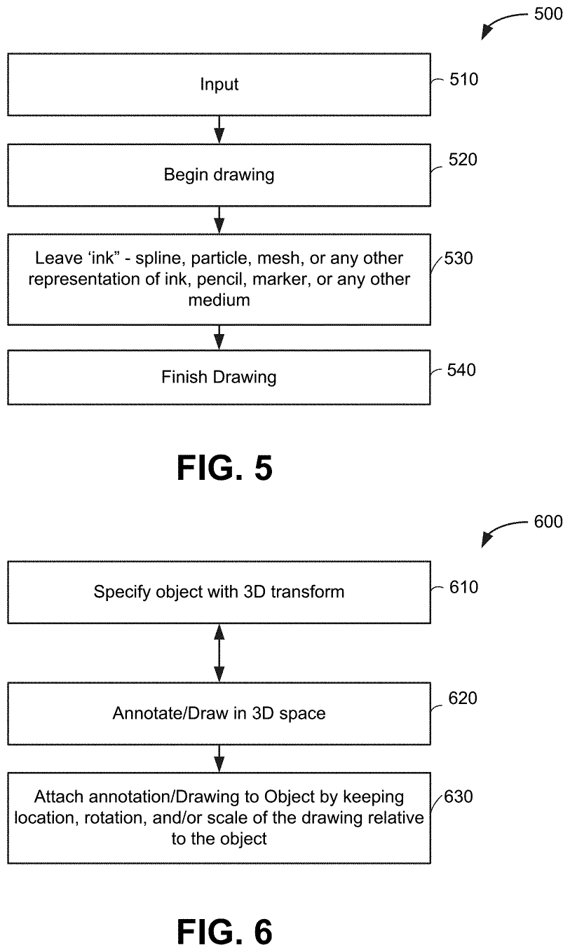

FIG. 5 depicts an exemplary three-dimensional annotation/drawing tool input flow 500, which allows for the processor to receive input from the controller. In step 510, input is created as the user begins drawing 620, which will provide the input device 110 (FIG. 1) and the processor 130 will cause the pen to “move” in three-dimensional space to a new position with input that it will send to the processor 130. After the input is received, the drawing is begun in step 620, which begins the creation of ink points 220 in step 530 (FIG. 5). An ink point is a point in space that defines the origin of a mesh, or a point along a spline, for use with a spline point, particle trail, mesh, or other representation of ink or drawing medium. As the ink points are created “move pen” input is received, the ink points are left in the medium, which will create an ink trail by leaving multiple ink points at fixed distance and time intervals from the previous ink point. The ink points may be a set of splines, particles, a mesh, or any other three-dimensional asset that could represent ink, in some embodiments. In other embodiments of the process described herein, the “Virtual Ink” may be paint, pencil, marker, highlighter, or any other ink-like medium. The user may then use the input device 110 to send input 510 (FIG. 5) through the processor 130 to signal to finish the drawing, which will cease the input flow 510 and stop the creation of ink point. One embodiment of the method described would then ensure the embodiment is oriented so that the asset implies the direction the pen was moving. In step 540, the user may then conclude the drawing by signaling the input device 110 to stop sending input, which sends a message to the processor 130 to finish drawing 540.

FIG. 6 depicts a method 600 for concluding the three-dimensional annotation/drawing that will associate the annotation with a three-dimensional Object. Once the annotation is drawn, it will maintain the same relationship with the Object, relative to the distance, location, or scale that the annotation and the Object shared when the annotation was created. When the first “ink point”is created in relation to the Object, the rasterizing software recognizes the “ink point” as the Object's child and the Object as the “ink point's” parent. As “ink points” are created, they are stored in a Spline Mesh Component, which contains only the child points. In this embodiment, the parent and children maintain the same relationship in location, orientation, and scale because the parent and children are attached within the software by a mathematical equation (known in the game industry) that multiplies the location of each linked child by the previous child, until reaching the parent Object. Each consecutive “ink point” is linked to the “ink point” before it, until the parent Object is reached, like a chain. In this regard, the ink points are stored in a “spline mesh component” that is the child of the parent Object. Points that are stored within that component are only related to the component, and not to the parent.

As depicted in FIG. 6, this relationship can be created using multiple methods. First, by selecting the three-dimensional Object as described in 610, then performing the annotation 620, the processor 130 (FIG. 1), will then attach the annotation to the three-dimensional asset 630. Alternatively, the annotation can be created first 620, then the three-dimensional Object selected 610 and linked to the previously created annotation 630. FIG. 6 depicts one embodiment of the user specifying which object will be annotated. In the present disclosure, the method will then use mathematics, such as three-dimensional transforms, or the constructs offered by the user's rasterizing software to keep the location, orientation, or scale of the finalized annotation relative to the previously defined Object.

Further, standard constructs of game engine and game development are used to specify objects in the virtual world. This could be based on a collision that takes place between the user's hand, for example, and the object to be selected. Or, alternatively, other ways can be used to specify which object to select. The 3D transform specifies the location of the object, its orientation, and its scale, and provides the basis for the calculations used to attach the ink.

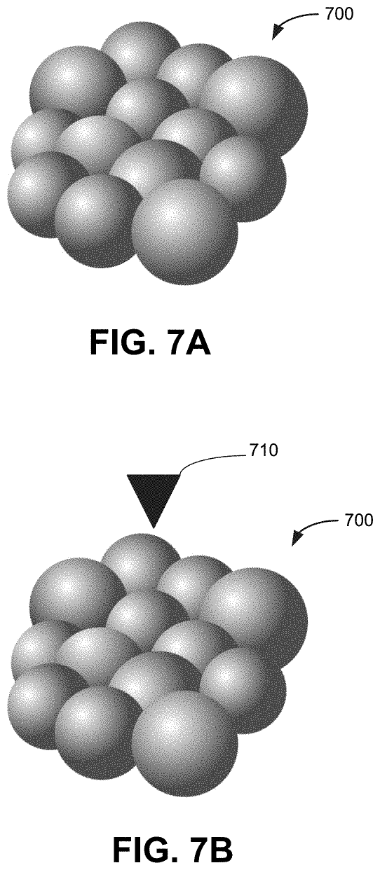

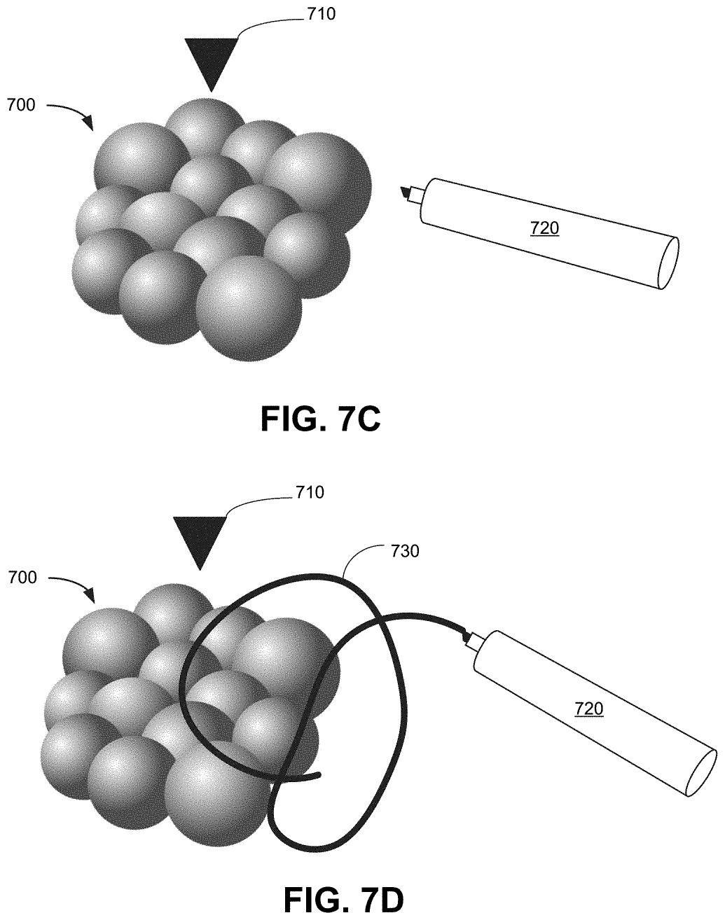

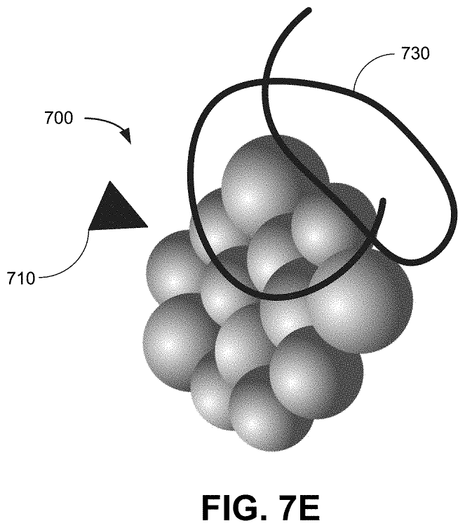

FIG. 7A depicts an Object 700 being visualized in three-dimensional space. The object may be Instanced Static Mesh, a Particle, a billboard, a static mesh, a skeletal mesh, or any other method to represent three-dimensional assets. In this exemplary figure, the mesh is instanced static mesh. In other examples, the object could be a particle, a billboard, a static mesh, a skeletal mesh, or another method used to represent 3D assets.

FIG. 7B depicts the selection of an aspect 710 of that Object 700 of note for annotation. FIG. 7C depicts an image of a virtual highlighter 720 that is the annotation tool in this example. Alternatively, the tool used could be representative of any tool related to writing, drawing, painting, or transferring “Virtual Ink” from user input to visualization.

FIG. 7D illustrates a “Virtual Ink” trail represented by a streak 730 on the object 700. Alternatively, the “Virtual Ink” may be represented by splines, particles, meshes, or other visualization techniques. Either before, during, or after creation, the pen streak 730 is associated with the object, according to the methods described herein.

FIG. 7E demonstrates that the XR annotation 730 rotates with the Object 700, after the XR annotation has been created. In this figure, the Object 700 has been rotated about 90 degrees counter-clockwise, and the XR annotation 730 made by the highlighter Tool has moved with the Object in the same relation to the Object.

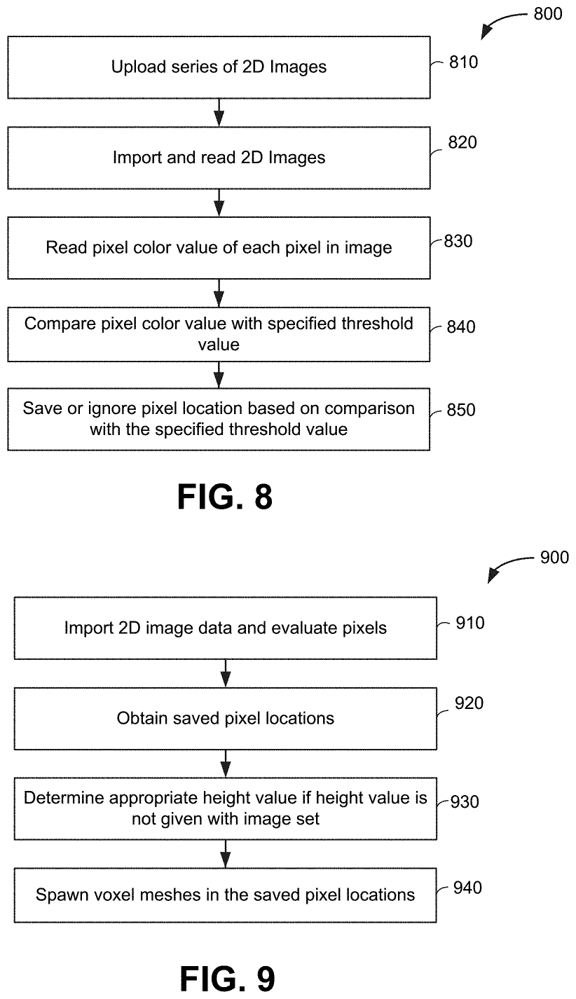

FIG. 8 depicts a method 800 for importing and analyzing data according to a threshold or range of values, in accordance with an exemplary embodiment of the present disclosure. In step 810, the user uploads a series of two-dimensional images to create a three-dimensional mesh. This can be done through a graphical user interface, copying the files into a designated folder, or another upload method. In step 820, the processor imports the two-dimensional images. In step 830, the software loops through the rows and columns of each two-dimensional image and evaluates each pixel and reads the color values of each pixel. In step 840, the software compares each individual pixel color value for the image against a specified threshold value. The threshold value can be user-defined or computer-generated. In step 850, the software saves and tracks the location of pixels with a color value above the specified threshold, or within a range of values. Pixels outside of the desired threshold are ignored, i.e., are not further tracked or displayed. The pixels may be saved in a variety of ways, such as: an array associated with a certain image, a text file, or other save methods.

FIG. 9 depicts a method 900 of creating the voxel representation of the uploaded series of images according to an exemplary embodiment of the present disclosure. Step 910 shows the method 800 (FIG. 8) in the context of pixel creation. In step 920, the software receives each of the saved pixel locations. In step 930, the software evaluates the height value of a vector's location. Two-dimensional images only have locations on two planes. In this example, those directions are defined as “x” and “y,” but they can be any combination of planes in three-dimensional space. If the two-dimensional image does not supply the third value, in this example “z,” the software will determine the third value either by user-specified increments or computer-generated increments. If the two-dimensional image supplies its own third value, then the software uses it. For example, medical images provide the third value in their header files. If no height value is given, the software determines the appropriate height value, either by user-defined increments or a default increment.

In step 940, the software spawns a voxel mesh at the three-dimensional location. In this example, the software does this by adding an instance to a hierarchical instanced mesh at the location provided. Once the spawning is complete, the voxel buildup (a three-dimensional model) is ready to be viewed and examined. The user may manipulate the set of voxels as if they are one mesh.

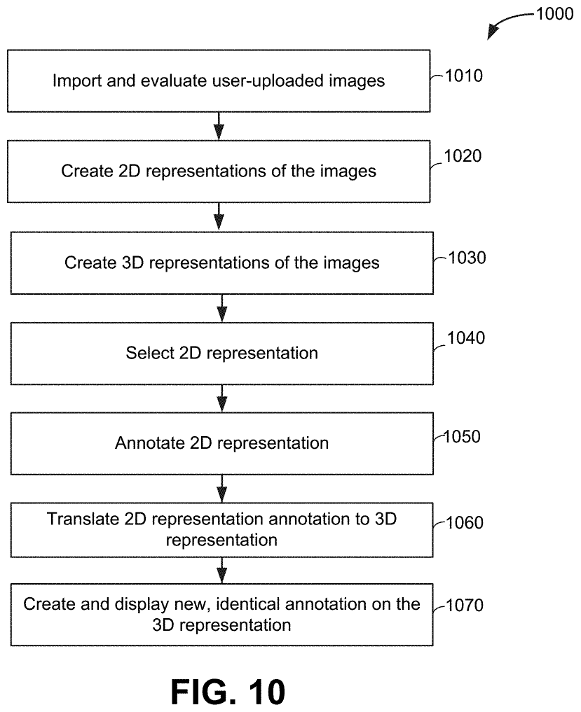

FIG. 10 depicts a method 1000 of linking or translating the annotations made on a two-dimensional representation to a three-dimensional representation. In step 1010, data is imported, and image data is converted to create assets (as described above). In step 1020, the software uses the two-dimensional images to spawn a virtual three-dimensional plane and applies the material to the plane. This results in an equal number of planes to number of uploaded images with each image represented by a plane. In step 1030, the software then creates a three-dimensional representation of the images (as described above). In step 1040, the user chooses a two-dimensional image to annotate. In step 1050, the user makes an annotation on the selected two-dimensional image. Once the user completes the annotation, in step 1060 the software translates or mirrors the annotation from the two-dimensional image onto the corresponding three-dimensional image. The mirrored annotation will reflect the original annotation in scale, location, and color. In step 1070, the new mirrored annotation is spawned on the three-dimensional location corresponding to the original annotation on the two-dimensional image.

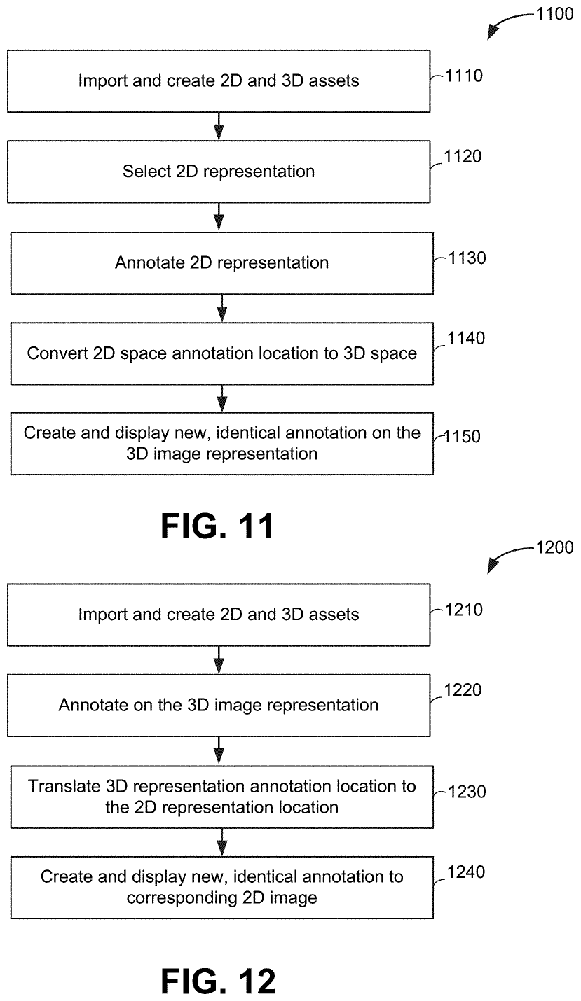

FIG. 11 depicts a method 1100 of linking or translating the annotations made on a two-dimensional representation to a three-dimensional representation according to an embodiment of the present disclosure. In step 1110, the user inputs images, which the processor 130 (FIG. 1) evaluates. In step 1120, the user selects a two-dimensional representation and in step 1130, annotates the two-dimensional representation. In step 1140, the processor then converts the location of the two-dimensional annotation to the location into three-dimensional space. In step 1150, an identical annotation is created and displayed on the three-dimensional image.

FIG. 12 depicts a method 1200 of linking or translating annotations made on a three-dimensional representation to a two-dimensional representation. In step 1210, the processer 130 (FIG. 1) imports and creates two-dimensional and three-dimensional images. In 1220, the user selects a three-dimensional representation and in step 1230, the user annotates the three-dimensional representation. In step 1240, the processor 130 then converts the location of the three-dimensional annotation to the location into two-dimensional space and creates and displays the identical annotation onto the two-dimensional image.

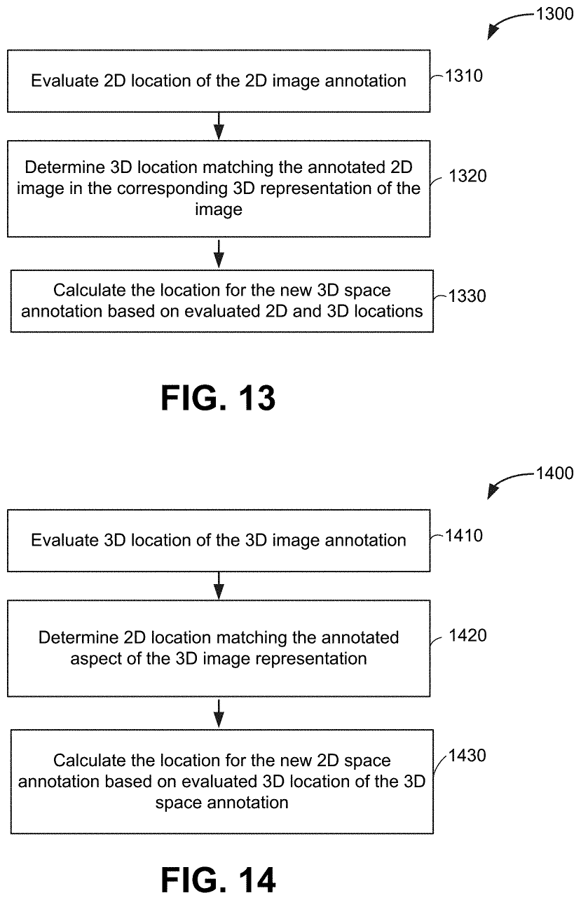

FIG. 13 depicts an exemplary method 1300 of converting two-dimensional space annotations to three-dimensional space annotations, the data representing those assets, and the communication between that data and the software, which leads to the representation on the XR platform. In step 1310, the processor 130 (FIG. 1) analyzes the location of the two-dimensional annotation. In step 1320, the processor 130 determines the three-dimensional location that corresponds with the two-dimensional annotation location. In step 1330, the processor 130 calculates the location for the new three-dimensional annotation based on the evaluated location of the two-dimensional annotation location.

FIG. 14 depicts an exemplary method 1400 of converting three-dimensional space annotations to two-dimensional space annotations. In step 1410, the location of the three-dimensional location of the three-dimensional assets is analyzed by the processor 130 (FIG. 1). In step 1420, the processor 130 determines the two-dimensional location that matches the three-dimensional annotation location. In step 1430, the processor 130 calculates the location for the new two-dimensional annotation based on the evaluated location of the three-dimensional annotation location.

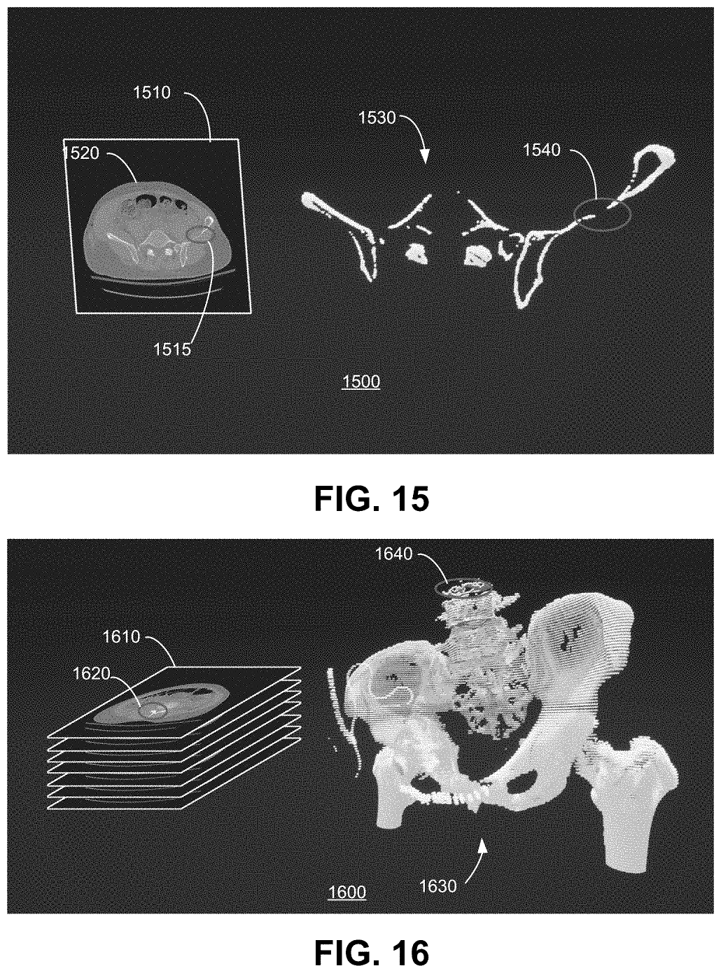

FIG. 15 depicts an exemplary annotated two-dimensional image 1510 next to a corresponding annotated three-dimensional representation 1530 in a virtual space 1500, created using the method disclosed herein. The two-dimensional image 1510 is of a portion of a human body 1520, and a user has drawn an annotation 1515, in this example a red oval around a feature on the image 1510. The three-dimensional representation 1530 in this example has been created with a threshold set to display only bone. The user has drawn the annotation 1515 on the two-dimensional image 1510, and the annotation is mirrored by the corresponding annotation 1540 in the three-dimensional image 1530 using the method described above. The corresponding mirrored annotation 1540 is created on the corresponding three-dimensional representation 1530 to the same scale, location, and orientation.

FIG. 16 depicts a deck (or stack) 1610 of two-dimensional images next to a corresponding three-dimensional voxel mesh 1630 in a virtual space 1600. An annotation 1620 has been drawn on an image in the deck 1610, in this example, a red oval to mark a feature on the image. The three-dimensional voxel mesh 1630 has been created with a threshold set to display only bone as shown. The three-dimensional voxel mesh 1630 displays a mirrored annotation 1640 in the same location, scale and orientation as the two-dimensional image.

The user can change colors of the annotations based on the user's preference. The user can change the color of the new annotations in multiple ways. This color changing could be done through selecting from a color wheel or a few selectable color swatches, input on a controller, or input on another input device. In one exemplary embodiment, a virtual monitor allows the user to select the new color from a few color swatches. The user interacts with the monitor by pressing a virtual button on the monitor that displays the color. Once the button is pressed, the color of the coloring tool changes to the newly selected color. Every annotation made after the new color selection will be the selected color until a new color selection is made. All placed annotations will keep the same color they were when they were placed in the virtual environment. This functionality allows for the user to create different annotations in a variety of colors.

In one exemplary embodiment, there are three different modes for the annotation tool. These modes are: Draw, Hide, and Delete. The user changes between these modes by pressing the defined tool mode button on the controller. The tool mode button can be mapped to any button press on any input device. When the user changes the mode, the tool mode visuals change to indicate to the user what mode is active.

In one exemplary embodiment, the user can select the visibility of an annotation. There are two visibility modes in one embodiment. The first mode is that the full opaque color of the annotation is shown. The second visibility mode is that the annotation color is changed to a translucent grey. In order to toggle the visibility of the annotation, the tool needs to be in Hide mode. Once the controller is in Hide Mode, then the user will select the annotation he or she wishes to hide by intersecting the controller with the annotation and pulling the trigger. This trigger pull will toggle the visibility mode of the overlapped annotation meaning if the annotation was visible then the annotation mode changes to hidden or vice versa.

The purpose of adding this capability is for users to be able hide or unhide selected annotations. This capability would be useful in a teaching scenario where the user would be able to dynamically toggle the visibility of the annotations based on what he or she is currently discussing. This toggling of visibility allows the user to focus the audience's attention to one or more areas that pertain to what the user is discussing based on the current visible annotations.

In one exemplary embodiment, the user has the ability to delete annotations. The user can either delete one annotation or all of the annotations at once. In order to delete one annotation, the tool will need to be in the Delete Mode. Once in Delete Mode, the user will select the annotation he or she wants to delete by intersecting the controller with the annotation and pulling the trigger. This trigger pull will then delete any overlapping annotations. In order to delete all of the annotations at once, the user will need to press and hold a specified button on the controller or input device for a specified amount of time. When the button is pressed and held a timer will appear and is active for the entire time the button is pressed. Upon completion of the timer, all annotations will be deleted.

In one exemplary embodiment, the user has the ability to dynamically change the scale of the annotations based on user preference. To access this capability, the user puts the tool in Draw mode. Once in Draw mode, the user can then dynamically change the width of the pen used to make the annotation by pressing a specified button or a key on an input device. Currently, this is accomplished by rotating the input on the thumbpad. This capability allows the user to select the desired thickness of the annotation to be made. It can also be used to place emphasis on certain annotations by making them thicker and leaving the other annotations smaller.

In one exemplary embodiment the user has the ability to attach an annotation to an object based on priority. This selection based on priority allows for the programmers or the users to dynamically determine object priority based on preference or logic. The attachment process is automatically triggered once the user has finished drawing the annotation. Once the annotation has been placed in the world, the software looks for the closest object within a certain distance to the annotation. If two objects are found with the same distance to the annotation, then the annotation is attached to the object with the higher priority. If the annotation does not find an object within the specified distance, then it will not attach or anchor to any object. The unattached annotation will still be visible and exist in the virtual environment it will just not be attached to anything.

In one exemplary embodiment the user has the ability to save and load annotations from previous game sessions. In order to accomplish this task, various attributes of an annotation are saved and then retrieved on loading of the annotation. The annotation is then recreated using these saved attributes. Some attributes saved are spline locations, attachment flag, and the color of the annotation. These variables allow for the annotation to be recreated exactly how it was saved. The software recreates the spline or annotation based on the saved spline locations. If the attachment flag is true, then the annotation will reattach to the object it was attached to before. The color of the annotation will also be recreated based on the saved color value.

What is claimed is:

1. A method for annotating images in a virtual space comprising:
uploading one or more two-dimensional images;
creating one or more two-dimensional representations of the images in the virtual space;
creating a three-dimensional representation from the one or more two-dimensional representations and displaying the three-dimensional representation in the virtual space;
making an annotation on either a two-dimensional representation or the three-dimensional representation within the virtual space to create an annotated representation;
automatically translating the annotation from the annotated representation to the two-dimensional representation or three-dimensional representation that was not annotated;
displaying the annotation real-time in both the two-dimensional representation and three-dimensional representation.

2. The method of claim 1, wherein the annotated representation is displayed in the same relationship in size and location on the three-dimensional representation regardless of any manipulation that the three-dimensional representation is subsequently subjected to.

3. The method of claim 1, wherein the annotation is made within the virtual space using a virtual annotation tool.

4. The method of claim 3, wherein the annotation is displayed in a color.

5. The method of claim 4, wherein the color is changeable by a user via the virtual annotation tool.

6. The method of claim 3, wherein the virtual annotation tool provides options to draw, hide and delete annotations in the virtual space.

7. The method of claim 3, where a user can hide and unhide an annotation by toggling a visibility selector on the virtual annotation tool.

8. The method of claim 1, further comprising selectively deleting one or more annotations.

9. The method of claim 8, further comprising deleting annotations that overlap within the virtual space.

10. The method of claim 1, further comprising attaching the annotation to an object within the two-dimensional representation or the three-dimensional representation.

11. The method of claim 10, wherein the step of attaching the annotation to an object within the two-dimensional representation or the three-dimensional representation further comprises attaching the annotation to the object within the two-dimensional representation or the three-dimensional representation that is closest to the annotation.

12. The method of claim 11, wherein if more than one object within the two-dimensional representation or the three-dimensional representation is the same distance from the annotation, attaching the annotation to the object with a higher priority level.

13. The method of claim 12, wherein the user determines the priority levels of the objects.

14. The method of claim 13, wherein if an annotation is not within a user-specified distance to any object, the annotation is not attached to any object.
